(19) United States
(12) Patent Application Publication
(10) Pub. No.: US 2026/0322690 A1
(43) Pub. Date: Oct. 15, 2026

(54) DETECTION OF NETWORK SERVICE(S) WITH DEVICE CONFIGURATION DATA

(71) Applicant: Cisco Technology, Inc., San Jose, CA (US)

(72) Inventors: Carl Christian Rennerskog, Enskede (SE); Viktoria Fordos, Varmdo (SE)

(21) Appl. No.: 19/285,987

(22) Filed: Jul. 30, 2025

Related U.S. Application Data
(60) Provisional application No. 63/785,867, filed on Apr. 9, 2025.

(51) Int. Cl. H04L 41/084; H04L 41/0816; H04L 41/0869

(52) U.S. Cl. CPC H04L 41/084; H04L 41/0816; H04L 41/0869

(57) ABSTRACT

Automated detection and migration of network service(s) across network(s) based on existing device configuration(s). Many service provider networks pre-date network controllers and are operated in a brownfield fashion, within many tools and operators accessing network elements and making out-of-band changes. These changes introduce security and other concerns to a network and make migration to a network controller extremely difficult and costly. The techniques enable automated migration of hand-crafted configuration(s) to the network controllers using existing device configuration(s) of a network. The techniques may enable a network controller to identify existing service types, implement them in a language the network controller understands, and then perform service discovery to let the network controller take ownership of existing service instances.

### CROSS REFERENCE TO RELATED APPLICATIONS

This application claims priority to U.S. Provisional Patent Application No. 63/785,867, filed Apr. 9, 2025, the entire contents of which are incorporated herein by reference.

### TECHNICAL FIELD

The present disclosure relates generally to computer networking, and more particularly to automatic detection of network service(s) in a network using device configuration data.

### BACKGROUND

Brownfield environments may refer to scenarios where a network controller is out of sync with one or more devices. For instance, in large-scale networks, out-of-band (OOB) changes occur often. For instance, there may be more than one entity (e.g., such as network users, scripts, multiple network controllers, etc.) making changes to the same set of devices. As an example, service provider networks may be operated with many tools and users accessing network elements and making changes directly out of band from the network controller to realize different network functions (e.g. setting up a VPN). Further, many of the changes are made via various hand-crafted configuration code snippets, which introduce security vulnerabilities, increase errors within the network, and increase operational costs. Accordingly, operating such large-scale networks pose unique challenges to network controllers.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture for enabling an orchestrator to perform automatic detection of network services using device configuration data.

FIGS. 2A and 2B illustrate example reference trees that may be generated as part of service type discovery, according to the techniques described herein.

FIG. 2C illustrates an example schema tree that may be generated as part of service type discovery, according to the techniques described herein.

FIGS. 3A-3C illustrate example flow diagrams for performing service type discovery and service instance discovery, according to the techniques described herein.

FIG. 4 illustrates a component diagram of an example orchestrator that can be utilized to implement aspects of technologies disclosed herein.

FIG. 5 illustrates a flow diagram of an example method of automatic detection of network services, according to the techniques described herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

The present disclosure relates generally to computer networking, and more particularly to automatic orchestrator detection of network service(s) in a network using device configuration data.

The present disclosure describes a method for enabling an orchestrator to take ownership of network service(s) in a brownfield environment by performing service type discovery and service instance discovery. The method may include receiving, from a user device, input indicating one or more network devices of a plurality of network devices across the network; determining, based on the input, one or more patterns between one or more device configurations of the one or more network devices; generating, based on the one or more patterns, a configuration template comprising a device schema including processing instructions indicating mappings between a service intent to the one or more device configurations across one or more devices in the network; generating, based in part on the configuration template, a service type comprising a schema representing a device configuration of the service type; generating, based on the service type, a reverse mapping between one or more service instances of the service type based on existing device configurations within the network, the reverse mapping comprising a list of service intents deployed in the network; and performing, based on the reverse mapping, service instance discovery to take ownership of the device configuration to the network controller.

Additionally, the techniques described herein may be performed by a system and/or device having non-transitory computer-readable media storing computer-executable instructions that, when executed by one or more processors, performs the method described.

### Example Embodiments

Brownfield networks may refer to an environment where a network controller is out of sync with one or more devices. For instance, in large-scale networks, out-of-band (OOB) changes occur often. For instance, there may be more than one entity (e.g., such as network users, scripts, multiple network controllers, etc.) making changes to the same set of devices. As an example, service provider networks may be operated with many tools and users accessing network elements and making changes directly out of band from the network controller to realize different network functions (e.g. setting up a VPN). In another example, a controller may be unable to sync with another controller due to the other controller being associated with a large, non-transactional device (e.g., such as Meraki dashboard, AWS dashboard, etc.). Accordingly, operating such large-scale networks can pose unique challenges to network controllers. For instance, many of the changes are made manually using hand-crafted configuration code snippets. Thus, a network device may comprise thousands of hand-crafted configurations, which can introduce security vulnerabilities, increase errors within the network, and increase operational costs. Accordingly, operating such large-scale networks pose unique challenges to network controllers.

To mitigate these problems, a network administrator may attempt to migrate the service(s) associated with the device configurations. Thus, by enabling the network controller to assume ownership of and bring the device configuration(s) into lifecycle management, the network controller may mitigate these problems through automation and programmatic control over creation, update, and deletion of network services defined by its configuration data. However, migration of configuration data and hand-crafted configuration data to a network controller is extremely complex. As noted above, a single network device may comprise hundreds or thousands of different hand-crafted configurations. Due to the differences between each configuration, migration to the network controller is currently performed manually and can take years to complete. Further, due to the complexity, users performing the migration require a high degree of network expertise in order to avoid introducing further errors, security vulnerabilities, etc. to the network. Given migrations are performed manually, errors may still be introduced to the network, which can result in security vulnerabilities, increased error ratio(s), and increased computational cost(s). For instance, existing techniques may cause the data store of the network controller to be spoiled with unhandled OOB data (e.g., such as when OOB handling fails due to device errors) and network devices may receive stale updates from the network controller, which can result in a device error (e.g., such as the network device committing an incorrect configuration) and can result in service being lost throughout the network (e.g., such as where the device is a server, etc.).

The techniques may be implemented by an orchestrator of a network, and may include receiving, from a user device, input indicating one or more network devices of a plurality of network devices across the network; determining, based on the input, one or more patterns between one or more device configurations of the one or more network devices; generating, based on the one or more patterns, a configuration template comprising a device schema including processing instructions indicating mappings between a service intent to the one or more device configurations across one or more devices in the network; generating, based in part on the configuration template, a service type comprising a schema representing a device configuration of the service type; generating, based on the service type, a reverse mapping between one or more service instances of the service type based on existing device configurations within the network, the reverse mapping comprising a list of service intents deployed in the network; and performing, based on the reverse mapping, service instance discovery to take ownership of the device configuration to the network controller.

As used herein, an “orchestrator” of a network may correspond to a network services orchestrator configured to perform controller functionalities and orchestration functionalities. As used herein, a “network controller” and/or “controller” may correspond to one or more of the controller functionalities performed by the orchestrator and/or to a separate controller managed by the orchestrator. For instance, the “controller” functionalities may include, but are not limited to configuration management (e.g., management of network devices, managing configuration(s) of device(s) in a network), state management (e.g., monitoring and managing state(s) of network devices and services, automatically recovering or remediating issues when deviations from the desired state are detected), abstraction (e.g., abstracting away the complexities of managing different types of network devices; providing a unified interface to a user device to enable the user to interact with various devices and their configurations), and transaction management (e.g., complex configuration changes in a transaction-safe manner, ensuring that all changes are applied together, portions are applied, or none are applied at all). The “orchestrator” functionalities may include, but are not limited to inter-device coordination (e.g., coordinating the actions of multiple network devices to achieve a larger network objective, such as deploying a specific service or modifying a network topology), service lifecycle management (e.g., managing entire lifecycle of network services, from deployment to modification to deletion), cross-domain automation (e.g., automating services across different network domains, including physical, virtual, and cloud-based infrastructure), integration with other systems (e.g., integrating with other automation and orchestration frameworks, such as DevOps tools, OSS/BSS systems, and business process workflows), etc.

In some examples, the orchestrator may be configured to enable fine-grained control over network infrastructure across multiple domains and can powerfully orchestrate the configuration life cycle of network(s). For instance, the orchestrator may be configured to treat the network as a database and may act as an authoritative source of the device configuration data. In some examples, the orchestrator may provide comprehensive lifecycle network service automation and full programmatic control over the network. The orchestrator may be model-driven, where all data follows a schema (e.g., such as a YANG model schema, etc.), and interfaces may be rendered automatically according to the schema(s).

In some examples, the orchestrator may be configured to provide multi-vendor abstraction using driver(s) (e.g., such as network element driver(s), or any other suitable type of driver). For instance, the orchestrator may mediate access to a plurality of different device types through the driver(s) (e.g., software package(s)). These drivers may implement the native device protocol while also providing a device model that comprises a configuration tree of the device configuration that is modeled in a particular schema language (e.g., such as YANG). The driver(s) may be configured to compute the ordered sequence of device-specific commands to go from a current to a desired state. Thus, the orchestrator may utilize the driver(s) to provide a uniform northbound API towards the devices and abstract the underlying protocol. Moreover, the driver(s) may enable a device component of the orchestrator to provide connection management, transactional configuration push, fine-grained configuration commands, and/or bidirectional device configuration synchronization.

In some examples, the orchestrator may comprise a service component. The service component may be configured to enable a user of the network (e.g., network operator, administrator, etc.) to manage high-level aspects of the network, network functions, etc. that span over the network infrastructure and/or across multiple domains. For instance, the service component may comprise a service type which may enable the user to configure network functions (e.g., such as the provisioning of VLANs), in a single place. In this example, the service component may determine the configuration changes required for each device in the network and may push the configuration changes to the network devices. In some examples, the service type(s) may be defined by a schema and their device configuration mappings (e.g., as templates, code, and/or a mix of both). In some examples, a service type is instantiated by providing a service intent comprising one or more service input parameters. Each service instance may represent an intent and ensures that the device configurations defined in its mapping are provisioned in the network. In some examples, service type(s) can be stacked on top of each other, providing abstraction possibilities. The lowest service type may be called the resource facing service, while the top service type is called the user facing service. Resource facing service types may comprise a simple mapping between service input and actual device configuration (typically with the help of templates) and may abstract away device configurations that are similar across devices. Even though resource facing service types are simple, they are crucial building blocks of programmable networks.

In some examples, the techniques described herein are directed to migrating running device configurations into resource facing service types. Thus, the orchestrator may use a mapping layer to map the service input (user intent) to the outputs (infrastructure configurations) so that user(s) (e.g., such as operators, network engineers, etc.) can define how a service should be deployed in the network. The service component may be customer facing (e.g., such that the service component receives input of user intent from northbound systems) and resource facing services (e.g., such that it configures the network elements).

As used herein a “service” may represent an abstraction that transforms a user intent into device configuration changes. As used herein a “service type” or a “service definition” may represent a declarative abstraction method for a network function that abstracts and automates a task a user may want to perform repeatedly. The service type may maintain mapping(s) between inputs (user intent) and outputs (infrastructure configurations). In some examples, the service type may comprise one or more of: (1) a data model (e.g., such as a YANG model) that defines the service in high level terms based on its input, (2) logic (e.g., program code in a programming language, DSL, etc. that collects information and performs verification), (3) a template (e.g., comprising process instructions defining how the service is rendered on device(s)), and/or (4) metadata (e.g., such as package metadata including version requirements, components, dependencies, etc.). As an example, the service type(s) may correspond to one or more of VLAN, policy deployment in segment routing, QoS policies, etc. In some examples, a service type may comprise an interface, a list of input parameters defined by a data model schema (e.g., model), that are required to instantiate the service type (i.e. to apply the processing instructions (e.g., template(s) with variable(s)) to generate a device configuration).

In some examples, the orchestrator may utilize template(s) (also referred to herein as “service templates”). For instance, the template(s) may be based on a markup language (e.g. such as XML) or any process instructions that can be used to map input to output programmatically. In some examples, the orchestrator may utilize the template(s) to simplify how configuration changes across devices of different types are applied and/or provide additional validation against a target data model. Templates are a convenient, declarative way of updating structured configuration data and allow you to avoid lots of boilerplate code. In some examples, the templates may be used to dynamically generate text or content and that they have common features like variables, expressions, control structures, data bindings, reusable parts etc.

In some examples, the orchestrator may be configured to perform service type discovery and/or service instance discovery. For instance, the orchestrator may perform the service type discovery and/or service instance discovery automatically and/or in response to receiving input (e.g., such as from a user, network elements, etc.). Service type discovery may comprise one or more steps. For instance, the service type discovery may include a first step, where the orchestrator may determine common patterns in one or more device configurations (indicated by the input) and/or repeated device configuration(s) across network devices. The orchestrator may use the common patterns and/or repeated device configurations to generate template(s) that encapsulate processing instructions on how to map service intent, the input, to an existing device configuration. In a second step of the service type discovery, the orchestrator may build a schema over the input parameters of a service, that together with the processing instructions will define a service type (e.g., a network function provisioned by the network controller).

Service instance discovery may be performed to generate one or more reverse mapping process instructions that define how to map device configuration into service type input (e.g., the service intent). Thus, by performing service instance discovery, the orchestrator may take ownership of and bring the device configuration into lifecycle management of the network controller. As an example, when the orchestrator performs service instance discovery (e.g., looks for service instance(s)), the orchestrator may look for values to be passed as input to the service type (generated as part of the service type discovery) to instantiate an instance that already exists in the network. For instance, a VLAN (e.g., a service type) may be deployed between A and B end points in the network. The service instance detection runs on existing device configurations across the network and may return X and Y, which may comprise values of input parameters required by the VLAN service type.

Thus, service type discovery may focus on generalizing common patterns in device configurations across devices, while service instance discovery may focus on finding the input parameters for service types such that the instantiated service type (e.g., the service instance), represents existing device configurations in the network.

Accordingly, the techniques described herein may provide an automatic process that solely depends on existing device configurations to identify service types in a brownfield environment and generate service types (including schema and template). Moreover, the system may provide a completely automatic algorithm solely depending on existing device configurations to perform service discovery. That is, by simplifying and providing automate service discovery of resource facing service types (and day zero/one/N configurations), the system may reduce operational complexity of the network(s). Further, by utilizing existing device configuration(s), the techniques improve network security by reducing false positives generated during service instance discovery. Further, the system may further determine structural dissimilarities in configuration based on given rate of recurrence. That is, the system may provide the ability to standardize service instances to avoid structural dissimilarities, also known as, configuration drift, thereby improving stability of network function(s) across the network(s).

For instance, the techniques may enable an orchestrator to identify and generate new service type(s) (e.g., including a schema and a template). That is, unlike existing techniques which are limited to template creation, the disclosed techniques provide the ability to generate and create both the service template and service schema for the service type using existing device configurations. Moreover, unlike existing techniques which require users to provide input specifying the service type, the reverse mapping(s), and/or reference service instance(s) in addition to the selection of device configuration(s), the techniques described herein may be performed solely using existing device configuration(s). This enables the system and user(s) to reduce development time by providing an automated means to produce resource facing service types on selected parts of a device's configuration tree, thereby streamlining the migration process, reducing the amount of network calls being made resulting in a reduction of bandwidth utilized across the network(s) and an improvement in throughput of the network.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

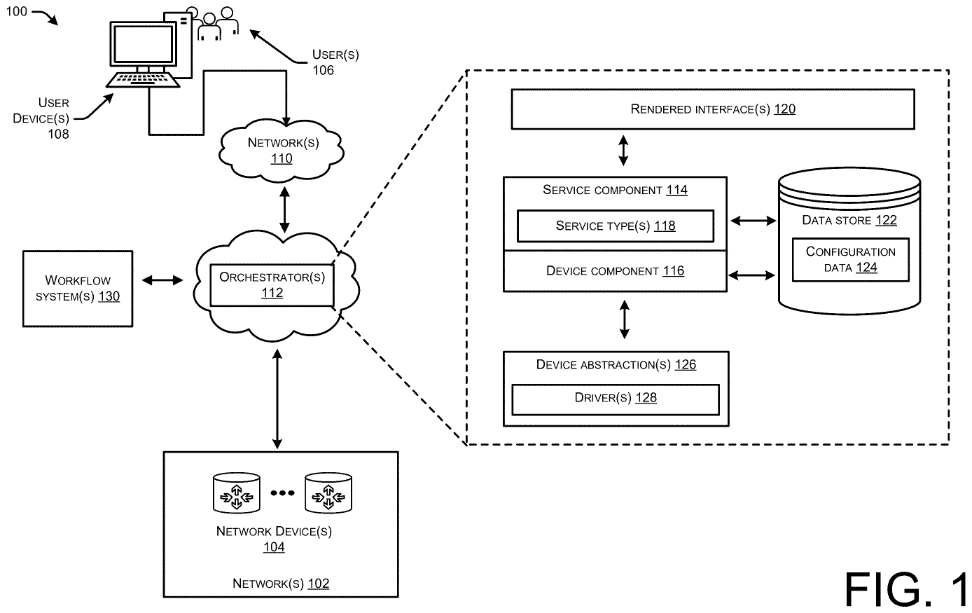

FIG. 1 illustrates a system 100 for enabling an orchestrator to perform automatic detection and migration of service(s) using device configuration data. The system 100 includes network(s) 102, in which user(s) 106 (e.g., administrators, operator(s), programmer(s), engineer(s), etc.) of user device(s) 108 and/or workflow system(s) 130 may utilize a domain-specific language to express and compile network functions to perform network operations across one or more domain(s).

FIG. 1 further illustrates an orchestrator 112 (also referred to as a controller or network controller herein) in the network(s) 102 configured to perform automatic detection and migration of service(s) using device configuration data. In some examples, the orchestrator(s) 112 may be implemented as part of an existing orchestrator framework, such as Crosswork Network Services Orchestrator provided by a vendor, such as Cisco.

In some examples, the network(s) 102 may include devices housed or located in one or more data centers. The network(s) 102 may include one or more networks implemented by any viable communication technology, such as wired and/or wireless modalities and/or technologies. The network(s) 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed-and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers. The network(s) 102 may include various hardware devices, such as routers, switches, gateways, smart NICs, NICs, ASICs, FPGAs, servers, and/or any other type of device. Further, the network(s) 102 may include virtual resources, such as VMs, containers, and/or other virtual resources.

The one or more data centers may be physical facilities or buildings located across geographic areas that are designated to store networked devices that are part of the network(s) 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples, the devices in the data networks may not be located in explicitly defined data centers, but may be located in other locations or buildings.

The user device(s) 108 may establish communication connections over one or more network(s) 110 to communicate with device(s) (e.g., such as network device(s) 104, orchestrator(s) 112, etc.) or other device(s) or services in the network(s) 102. The network(s) 110 may include any viable communication technology, such as wired and/or wireless modalities and/or technologies. Network(s) 110 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The user device(s) 108 may communicate using any type of protocol over the network(s) 110, such as the transmission control protocol/Internet protocol (TCP/IP) that is used to govern connects to and over the Internet.

As illustrated, the orchestrator(s) 112, may include service component 114, device component 116, data store 122, device abstraction(s) 126, rendered interface(s) 120. The orchestrator(s) 112 may include additional, alternative, or fewer components and are not limited to the components illustrated herein.

In some examples, the orchestrator(s) 112 are configured to perform controller functionalities and orchestration functionalities. For instance, the orchestrator(s) 112 may be configured to perform one or more of configuration management (e.g., management of network devices, managing configuration(s) of device(s) in a network), state management (e.g., monitoring and managing state(s) of network devices and services, automatically recovering or remediating issues when deviations from the desired state are detected), abstraction (e.g., abstracting away the complexities of managing different types of network devices; providing a unified interface to a user device to enable the user to interact with various devices and their configurations), transaction management (e.g., complex configuration changes in a transaction-safe manner, ensuring that all changes are applied together, portions are applied, or none are applied at all), inter-device coordination (e.g., coordinating the actions of multiple network devices to achieve a larger network objective, such as deploying a specific service or modifying a network topology), service lifecycle management (e.g., managing entire lifecycle of network services, from deployment to modification to deletion), cross-domain automation (e.g., automating services across different network domains, including physical, virtual, and cloud-based infrastructure), integration with other systems (e.g., integrating with other automation and orchestration frameworks, such as DevOps tools, OSS/BSS systems, and business process workflows), etc. In some examples, one or more of the above functionalities (controller functionalities and/or orchestration functionalities) may be performed by the service component 114 and/or the device component 116. For instance, the service component 114 may perform one or more of the functionalities associated with services of the network(s) 102. The device component 116 may be configured to perform one or more of the functionalities associated with device(s) of the network(s) 102.

In some examples, the orchestrator(s) 112 may utilize templates including process instructions or program code (e.g., XML templates) that may be used to map input to output programmatically. For instance, an engine of the orchestrator(s) 112 may be configured to receive a service intent associated with a one or more network device(s) 104 (e.g., such as a single network device and/or a set of network device(s)) and may perform a process flow to determine whether to commit, abort, and/or retry the transaction.

Service component 114 may be configured to communicate with data store 122. For instance, the service component 114 may be configured to receive an input (e.g., such as a service intent, a selection of device configuration(s), etc.) from user(s) 106 and/or workflow system(s) 130 (e.g., such as via rendered interface(s) 120). For instance, the service component 114 may receive the input via a Northbound Application Programming Interface (API). The service component 114 may be configured to access and/or update configuration data 124 in the data store 122 and/or device model(s) generated by driver(s) 128.

Workflow system(s) 130 may comprise network function(s), operating system service(s) workflow(s), basic service set workflow(s), and/or any other type of flow or function within the network.

Service component 114 may comprise service type(s) 118. The service type(s) 118 may translate intent to device configuration mappings and may provide full life-cycle management of device configuration, thereby reducing computational costs within the network. In some examples, the service type(s) 118 may be defined by a schema and their device configuration mappings (e.g., as templates, code, and/or a mix of both). In some examples, a service type is instantiated by providing a service intent comprising one or more service input parameters. Each service instance may represent an intent and ensures that the device configurations defined in its mapping are provisioned in the network.

Service component 114 may be configured to migrate existing service instances within the network into the lifecycle management of the orchestrator(s) 112. For instance, in order to migrate existing service instances into the network controller, the service component may be configured to: identify existing service types, implement the existing service type(s) in a language the network controller understands, and then perform service discovery to let the network controller take ownership of existing service instances.

In some examples, the service component 114 may utilize one or more algorithms or processes to perform migration of existing service instance(s). As described in greater detail below, the service component may perform a pre-conditioning step prior to performing service type discovery and/or service instance discovery.

In some examples, service type discovery may comprise two parts. Part 1 of the service type discovery may include finding common patterns in device configuration(s) and generating a service type template. Part 2 of the service type discovery may include building a service type schema. For instance, service types may have a well-defined interface that includes a list of input parameters that can influence intent delivery. In part 1 of service type discovery, the service component 114 may identify these parameters (with the paths we resolved by parameterization). Thus, part 2 of the service type discovery may generate the schema of the service type based on the location of parameterized nodes and the device schema used by the device configurations selected as input.

In some examples, service instance discovery may comprise discovering existing service intents deployed within the network(s) 102. For instance, the service component may create a reverse mapping that identifies all valid service instances of the service type(s) (generated as part of service type discovery), based on existing device configurations. Thus, the service component 114 may provide processing instructions to match the service type against the network(s) 102. For instance, the service component may perform service discovery by generating the reverse mapping and then topologically sorting the reverse mapping based on the constraints.

In some examples, the service component may then perform a process to evaluate the constraints based on the existing device configurations. The service component may identify a service instance where the evaluations have all queries result to a non-empty configuration node-set. As an example, the process to evaluate the constraints may include, for each tuple in the reverse mapping, determining whether there is a constraint. Where there is no constraint (e.g., such as when starting with the 1^{st} tuple), the process may execute the query in the network controller (e.g., XPath query, SPARQL (if OWL is the modelling language), SQL (if device configuration is represented in a relational database), or Java/Python code generated by the service component), where the query results in a node-set. The process may iterate over the node-set and for every element it binds the value of the element to the XPath variable as a resolved constraint and continues to evaluate the reverse mapping tuples. If the resulting node-set is empty, the process may break the current loop. The process may continue with the next element from the node-set.

The device component 116 may be configured to determine and deliver configuration changes to network device(s) 104. For instance, the device component 116 may calculate a southbound diff (e.g., a minimal set of operations (e.g., create, modify, delete, etc.) on the configuration level to deliver the change set to the network device). The device component 116 may utilize a Southbound API to deliver changes to the network device(s) 104, such as via device abstraction(s) 126 (e.g., representations of the network device(s) 104), and/or any other suitable component.

As illustrated, the device abstraction(s) 126 may comprise driver(s) 128. Driver(s) 128 may correspond to software package(s) configured to implement the native device protocol of a network device, while also providing a device model that comprises a configuration tree of the device configuration that is modeled in a particular schema language (e.g., such as YANG). The driver(s) 128 may be configured to compute the ordered sequence of device-specific commands to go from a current to a desired state. In some examples, the driver(s) 128 may generate configuration data 124 of existing service instance(s) and/or network device(s) of the network(s) 102 and/or network(s) 110 and provide the configuration data 124 to data store 122. Thus, the orchestrator may utilize the driver(s) to provide a uniform northbound API towards the devices and abstract the underlying protocol. Moreover, the driver(s) may enable a device component of the orchestrator to provide connection management, transactional configuration push, fine-grained configuration commands, and/or bidirectional device configuration synchronization.

Data store 122 may be configured to store state(s) and model(s) associated with the network controller and network device(s) 104. For instance, the data store 122 may store configuration data 124. Configuration data 124 may comprise service model(s) associated with service instance(s) within the network(s) 102 and/or network(s) 110, device model(s) associated with state(s) and configuration(s) of device(s) in the network(s) 102 (and/or network(s) 110), and/or any other suitable type of model. In some examples, the model(s) may comprise Yet Another Next Generation (YANG) models. YANG is a data modelling language for the definition of data sent over network management protocols such as the NETCONF, RESTCONF, CLI, SNMP, etc. YANG was first defined in RFC 6020 and can be used to model both configuration data as well as state data of network elements. YANG is a modular language representing data structures in an XML tree format. While examples described herein refer to YANG models, it is understood that the techniques described herein may utilize any modelling language in addition to, or as an alternative to YANG.

In some examples, the orchestrator 112 may receive input (also referred to as a service intent herein). The input may arrive through the rendered interface(s) 120, such as via a northbound API of the orchestrator 112. The rendered interface(s) 120 may include one or more application(s) associated with the network device(s) 104 and/or user device(s) 108. The input may correspond to a service intent for migrating existing service instance(s) to the orchestrator(s) 112. For instance, the service intent may comprise one or more of a selection of device configuration(s), a recurrence rate, access to network(s) 110, and/or an indication to perform migration. In some examples, device configuration data may follow a hierarchical schema model (for example modeled in the YANG modeling language as first defined in RFC 6020). In this example, the service intent may comprise user input including a selection of sub-trees of the device configuration(s) and a recurrence rate. The sub-trees of the device configuration(s) may be selected by, for example, XPath expressions or CLI commands translated into location paths into the configuration(s). In some examples, the selection can span across a plurality of device configurations.

Accordingly, the system may provide an automatic process that solely depends on existing device configurations to identify service types in a brownfield environment and generate service types (including schema and template). Moreover, the system may provide a completely automatic algorithm solely depending on existing device configurations to perform service discovery. That is, by simplifying and providing automate service discovery of resource facing service types (and day zero/one/N configurations), the system may reduce operational complexity of the network(s). Further, by utilizing existing device configuration(s), the techniques improve network security by reducing false positives generated during service instance discovery. Further, the system may further determine structural dissimilarities in configuration based on given rate of recurrence. That is, the system may provide the ability to standardize service instances to avoid structural dissimilarities, also known as, configuration drift, thereby improving stability of network function(s) across the network(s).

For instance, the techniques may enable an orchestrator to identify and generate new service type(s) (e.g., including a schema and a template). That is, unlike existing techniques which are limited to template creation, the disclosed techniques provide the ability to generate and create both the service template and service schema for the service type using existing device configurations. Moreover, unlike existing techniques which require users to provide input specifying the service type, the reverse mapping(s), and/or reference service instance(s) in addition to the selection of device configuration(s), the techniques described herein may be performed solely using existing device configuration(s). This enables the system and user(s) to reduce development time by providing an automated means to produce resource facing service types on selected parts of a device's configuration tree, thereby streamlining the migration process, reducing the amount of network calls being made resulting in a reduction of bandwidth utilized across the network(s) and an improvement in throughput of the network.

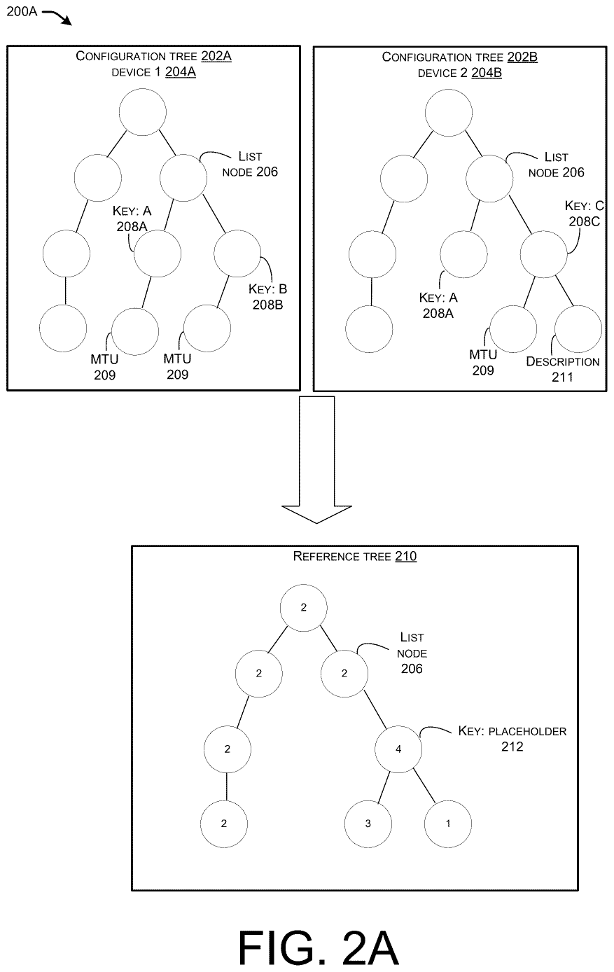

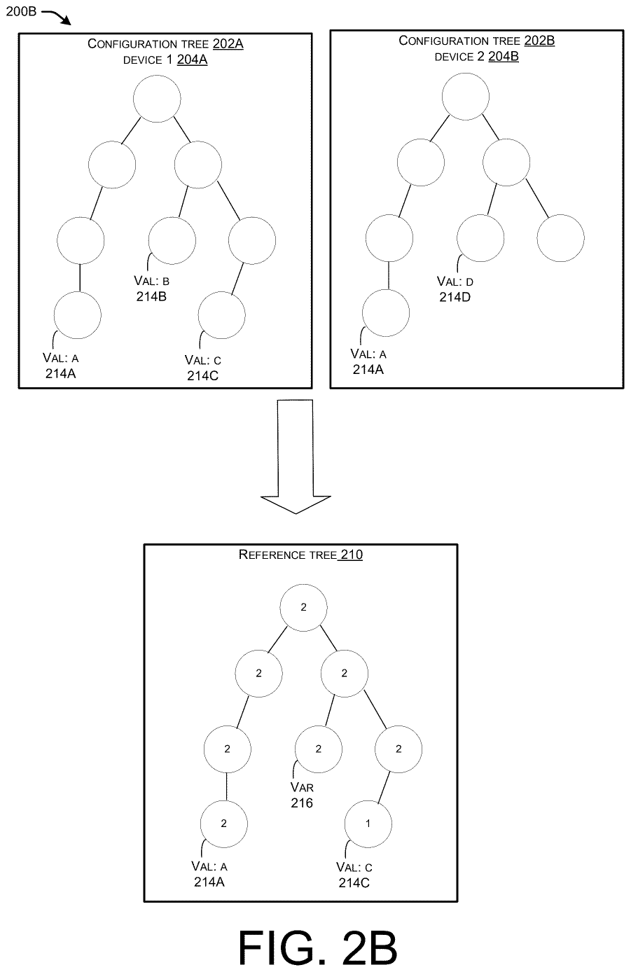

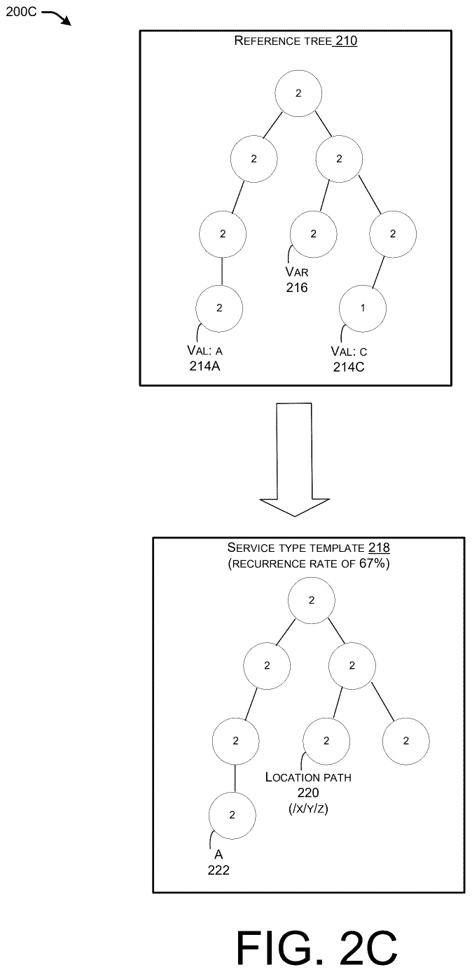

FIGS. 2A and 2B illustrate example environments that include configuration tree(s) associated with different device(s) in a network and a corresponding reference tree generated by the orchestrator as part of service type discovery, according to the techniques described herein. FIG. 2C illustrates an example environment a reference tree generated as part of the service type discovery, as well as a tree representing node(s) of a service type template that is generated when building the service type, according to the techniques described herein. FIG. 2A may correspond to an example where one or more configuration(s) of device(s) include list(s). FIG. 2B may correspond to an example where one or more nodes in configuration(s) of device(s) have different values. In some examples, FIGS. 2A and 2B may correspond to operation(s) performed under step 1 of service type discovery. FIG. 2C may correspond to operation(s) performed as part of step 2 of service type discovery.

As illustrated in FIG. 2A, the example process 200A may include configuration tree 202A for device 1 204A, configuration tree 202B for device 2 204B, and reference tree 210. In some examples, FIG. 2A may represent an example of a pre-step performed by the orchestrator, prior to building the reference tree 210 as part of step 1 of service type discovery. For instance, the orchestrator(s) 112 may perform the operations described in FIG. 2A where a data hierarchy construct defines list(s) and where list entries are identified by unique key(s). In this example, the orchestrator(s) 112 may perform special handling when comparing list(s) between different device configurations.

As illustrated, each configuration tree 202A and/or 202B may comprise one or more nodes. For instance, the configuration tree 202A may represent a device configuration of device 1 204A and configuration tree 202B may represent a device configuration of device 2 204B. As noted herein, the device configuration(s) may follow a hierarchical schema model (for example modeled in the YANG modeling language as first defined in RFC 6020), where the device(s) and/or configuration tree(s) are selected based on input received by the orchestrator. For instance, the input may identify device 1 204 and/or device 2 204B as potentially having service instance(s) to migrate to the orchestrator(s) 112. In this example, the orchestrator(s) 112 may identify one or more configuration tree(s) associated with device 1 204A and/or device 2 204B.

In some examples, the orchestrator(s) 112 (e.g., via the service component 114) may identify the configuration tree(s) based on the input. The orchestrator(s) 112 may, prior to generating the reference tree 210, traverse the selected device configuration(s). For instance, the orchestrator(s) 112 may utilize one or more algorithm(s), as described herein.

In some examples, the orchestrator(s) 112 may traverse the selected device configurations depth-first starting from the root node (vertical order) and may identify list(s) within the device configuration(s). For instance, the orchestrator(s) 112 may identify list node 206 as containing list key(s). The orchestrator(s) 112 may read the list key(s) (e.g., single list key, plurality of list key(s), etc.) stored at list node 206 and may hash the list key(s) to generate a single value representing the list key(s). The orchestrator(s) 112 may generate and save a tuple comprising (1) the location path 220 to the node (e.g., the list node 206) and (2) the hash.

The orchestrator(s) 112 may, use this tuple when generating reference tree 210. For instance, the tuple may be used when comparing the same location in the configuration tree between device 1 204A and device 2 204B. For instance, if the orchestrator(s) 112 determine the hashes match, nothing is done to the saved tuple. However, if the orchestrator(s) 112 determine the hashes are different, the hash of the two-tuple is changed to a value representing that the location path is different among the device configurations. In this example, the value may comprise “key: placeholder 212”.

As illustrated by reference tree 210, when building the reference tree, the orchestrator(s) 112 may use the saved tuples to determine whether a list node 206 for a given location should comprise a single placeholder key (which may subsequently be parameterized) or if the original key(s) (e.g., key A, 208A, key B 208B, and/or key C 208C) should be used. In the illustrated example, the reference tree comprises the placeholder key (e.g., key: placeholder 212). Thus, where the single placeholder is used, the orchestrator(s) 112 may store metadata comprising counts on how many times a specific configuration node occurs below key: placeholder 212 node ends up in the reference tree 210.

In the illustrated example, placeholder 212 node stores a count of “4” representing A 208A node occurred between configuration tree 202A of device 1 204A and configuration tree 202B of device 2 204B, B 208B node occurred between configuration tree 202A of device 1, C 208C node occurred between configuration tree 202B of device 2. A first node below the key: placeholder 212 node stores a count of “3” representing the number of times “mtu” leaf node 209 occurred between configuration tree 202A of device 1 204A and configuration tree 202B of device 2 204B. Moreover, a second node below the key: placeholder 212 node stores a count of “1” representing the number of times “description” leaf node 211 occurred between configuration tree 202A of device 1 204A and configuration tree 202B of device 2 204B.

As illustrated in FIG. 2B, the example environment 200B may include configuration tree 202A for device 1 204A, configuration tree 202B for device 2 204B, and reference tree 210. In some examples, FIG. 2B represents a reference tree 210 that is generated when the orchestrator(s) 112 perform part 1 of service type discovery (e.g., to find common pattern(s) among device configuration(s) of difference device(s)). In some examples, the operation(s) of FIG. 2A may be performed as a pre-conditioning step to the operation(s) of FIG. 2B. For instance, the orchestrator(s) 112 may perform the initial traversal of the device configuration(s) (e.g., configuration tree 202A and configuration tree 202B to identify and hash any list(s) and/or list key(s). In this example, the configuration tree 202A and configuration tree 202B may not comprise a list node 206.

In some examples, the orchestrator(s) 112 may traverse the selected device configurations depth-first starting from the root node (vertical order), gradually building a shadow tree structure, called a “reference tree”. The reference tree 210 may represent the least common denominator of device schema nodes that point to existing device configurations in the network. Thus, the schema expressed by the reference tree 210 may be compatible with the device schema(s) of device 1 204A and/or device 2 204B, since the reference tree has the same structure. Each node of the reference tree 210 may comprise data and/or metadata. For instance, the data and/or metadata may include, but is not limited to: an actual device configuration where the device configuration(s) are the same for a given path; metadata information (e.g., such as flags indicating that a value stored at a particular node is different for a given path across the device configuration(s)); a count indicating the number of times the node occurs for a given path across different device(s), etc.

For example, as illustrated in FIG. 2B, configuration tree 202A of device 1 204A and configuration tree 202B of device 2 204B have node(s) comprising val: A 214A. However, configuration tree 202A comprises a val: B 214B node and configuration tree 202B has a val: D 214D node at the same location. Further, val: C 214C node is only found in configuration tree 202A. In this example, the reference tree 210 may include val: A 214A node with a count of “2” indicating that val: A was found across both configuration trees. The reference tree 210 may include val: C with a count of “1” indicating that only one of the configuration(s) included the val: C 214C node at this location path. The reference tree 210 further comprises var 216, which may represent the difference in value(s) (e.g., val: B 214B and val: D 214D) between configuration tree 202A and configuration tree 202B at the location. The var 216 node may further comprise a count of “2” indicating that the node was found in both configuration trees.

As illustrated in FIG. 2C, the example environment 200C may include reference tree 210 and service type template 218. In some examples, FIG. 2C corresponds to operation(s) that may be performed following the operation(s) of FIGS. 2A and/or 2B. For instance, the operation(s) of FIG. 2C may correspond to building a service type template as part of step 2 of service type discovery.

In some examples, the tree of the service type template 218 may be generated by the orchestrator(s) 112 (e.g., such as by service component 114. For instance, the orchestrator(s) 112 may traverse the reference tree 210 depth-first. The identified reoccurring device configuration(s) (e.g., indicated by the count value(s) stored in the node(s) of reference tree 210) may be used to gradually build a matching configuration template with process instructions on how to map the service intent to an existing device configuration. As the reference tree is traversed, the orchestrator(s) 112 may determine, for each individual node, whether its sub-tree can be included in the service type template 218. For instance, the orchestrator(s) 112 may determine whether to include or prune a sub-tree based on the rate of recurrence (e.g., as provided as part of the original input). In the illustrated example, the rate of recurrence is set at 67%. Where the orchestrator(s) 112 determine to include the sub-tree (e.g., the sub-tree occurs at a rate greater than or equal to 67% across device configurations), the orchestrator(s) 112 may traverse further down in the reference tree 210 and may generating the service type template 218 (e.g., the service type template) at the same time. If it is decided to exclude the sub-tree, the orchestrator(s) 112 may move to a sibling node or moves further up in the reference tree 210 until it finds a sub-tree not yet traversed (or ends if all sub-tree(s) have been traversed). For instance, if a particular sub-tree is not found in at least 67% of the device configuration(s) across device(s), the orchestrator(s) 112 may determine to prune (e.g., exclude) the sub-tree.

In some examples, the orchestrator(s) 112 may, for any node flagged in the reference tree 210 as being different across the device configuration(s) for a given path and containing value(s), may resolve the difference by performing parametrization. For instance, the orchestrator(s) 112 may add in parameters (e.g., template variables (e.g., such as XML template variables, or any other variables across a suitable template protocol) and/or location paths matching a service type schema of the device configuration generated by the orchestrator(s) 112). In some examples, the orchestrator(s) 112 may refrain from parameterizing node(s) that are not list node(s) 206. For instance, for node(s) that comprise single value(s) and/or a variable, the orchestrator(s) 112 may use the original key value(s) of the node when generating template node(s). In some examples, the location paths work as processing instructions on where to find the service intent when it is mapped as device configuration.

In the illustrated example, the service type template 218 may utilize the original key value for val: A 214A (represented as A 222 in the template node(s). For the var 216 node, the service type template 218 may perform parameterization by including a location path 220. In the illustrated example, the sub-tree that included val: C 214C node is excluded from the service type template 218. For instance, the val: C 214C node occurred in 1 out of 2 of the configuration tree(s) (e.g., configuration tree 202A and configuration tree 202B). Accordingly, val: C 214C has a rate of recurrence of 50%, which is below the 67% rate of recurrence set by the input. Thus, the orchestrator(s) 112 may determine to exclude the val: C 214C node (and any node(s) within a sub-tree of val: C 214C node (not illustrated)) from the service type template 218 generated for the service type template.

As described herein, the service type template 218 may represent an intent to device configuration mapping that contains processing instructions (e.g., generated in XML template format). This template is used by the orchestrator(s) 112 to generate device configuration(s) when deploying service instances within a network. As described herein, the template contains variables (e.g., for example {/device}), that may be substituted with a corresponding value that is determined based on input parameters of the service instance that are received from by the orchestrator(s) 112.

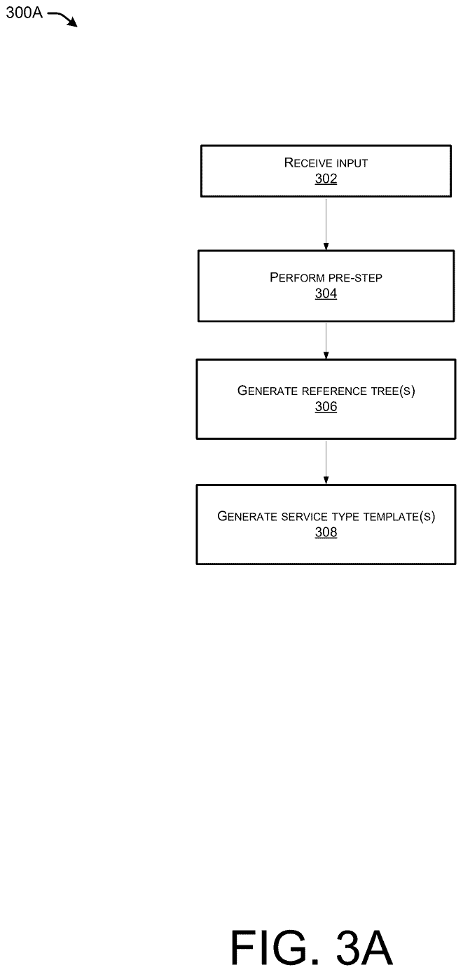

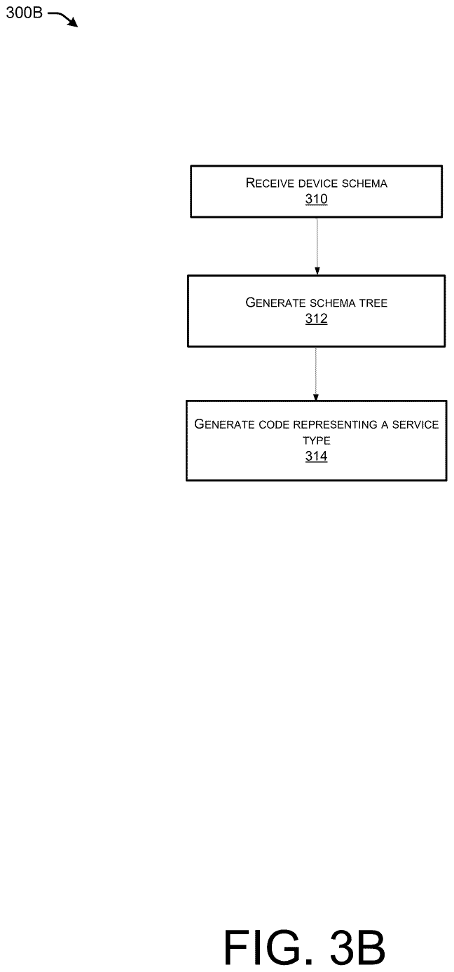

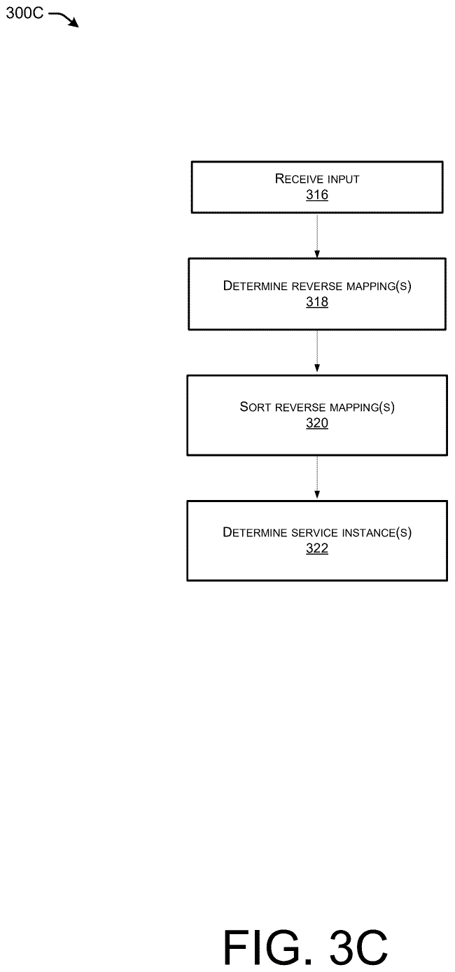

FIGS. 3A-3C illustrate flow diagrams of example processes for performing the techniques described herein. In some instances, one or more of the steps of process 300A, process 300B, and/or process 300C may be performed by a device (e.g., orchestrator 112, etc.) that includes one or more processors and one or more non-transitory computer-readable media storing computer-executable instructions that, when executed by the one or more processors, cause the one or more processors to perform one or more of the operations of process 300A, process 300B, and/or process 300C.

In some examples, FIG. 3A may correspond to an example process 300A associated with executing part 1 of service type discovery. FIG. 3B may correspond to an example process associated with executing part 2 of service type discovery. FIG. 3C may correspond to an example process 300C associated with executing service instance discovery, according to the techniques described herein. In some examples, one or more operations of process 300A may be performed independent of process 300B and/or process 300C. In some examples, one or more operations of process 300A may be performed prior to or following one or more operations of process 300B and/or process 300C.

At 302, the process 300A may include receiving input. As described herein, the input may be received from user device(s) (e.g., such as from an engineer, administrator, or other user of the network) and/or workflow system(s) of the network(s) 102. The input may include, but is not limited to, a selection of device(s) (e.g., device configuration(s)) associated with the network, a selection of sub-tree(s) of the device configuration(s) (such as via XPath expressions, CLI command(s) translated into location path(s) into the device configuration(s), etc.), a recurrence rate, etc.

In some examples, the input may include a day zero input requesting the orchestrator templatize device configuration(s) of a network being on-boarded. In some examples, the input may include an instruction to detect configuration drift across device configuration(s).

As an example and not by way of limitation, example device configurations for network device(s) that comprise IOS routers may be represented by the bolded language, as follows:
admin@ncs(config) #show full-configuration devices device ce* config policy-map
devices device ce0
   config
      policy-map a
      !
policy-map map1
   class c1
      bandwidth percent 50
      drop
      estimate bandwidth delay-one-in 500 milliseconds 100
      priority percent 33
      !
   !
   !
!
devices device ce1
   config
      policy-map a
      !
   policy-map map1
      class c1
         bandwidth percent 100
         drop
         estimate bandwidth delay-one-in 400 milliseconds 200
         priority percent 33
         !
      !
   !
!

At 304, the process 300A may include performing a pre-step. For instance, as described herein, the process 300A may traverse the selected device configurations depth-first starting from the root node (vertical order) and may identify list(s) within the device configuration(s). For instance, the process 300A may identify one or more nodes within a device configuration as containing list key(s). The process 300A may read the list key(s) (e.g., single list key, plurality of list key(s), etc.) stored at list node 206 and may hash the list key(s) to generate a single value representing the list key(s). The process 300A may generate and save a tuple comprising (1) the location path to the node and (2) the hash.

At 306, the process 300A may include generating reference tree(s). For instance, the process 300A may traverse the selected device configurations depth-first starting from the root node (vertical order), gradually building a shadow tree structure, called a reference tree 210. The reference tree 210 may represent the least common denominator of device schema nodes that point to existing device configurations in the network. Thus, the schema expressed by the reference tree 210 may be compatible with the device schema(s) of device(s) selected by the input, since the reference tree has the same structure. Each node of the reference tree 210 may comprise data and/or metadata. For instance, the data and/or metadata may include, but is not limited to: an actual device configuration where the device configuration(s) are the same for a given path; metadata information (e.g., such as flags indicating that a value stored at a particular node is different for a given path across the device configuration(s)); a count indicating the number of times the node occurs for a given path across different device(s), etc.

At 308, the process 300A may include generating service type template(s). In some examples, the process 300A may traverse the reference tree depth-first. The identified reoccurring device configuration(s) (e.g., indicated by the node(s) of reference tree 210) may be used to gradually build a matching configuration template (e.g., the service type template) that includes process instructions on how to map the service intent to an existing device configuration within the network(s) 102. As the reference tree is traversed, the process 300A may determine, for each individual node, whether its sub-tree can be included in the service type template 218. For instance, the process 300A may determine whether to include or prune a sub-tree based on the rate of recurrence (e.g., as provided as part of the original input). Where the process 200A determines to include the sub-tree, the process 200A may traverse further down in the reference tree 210 and may generate the service type template at the same time. If it is decided to exclude the sub-tree, the process 300A may move to a sibling node or moves further up in the reference tree 210 until it finds a sub-tree not yet traversed (or ends if all sub-tree(s) have been traversed).

In some examples, the process 300A may, for any node flagged in the reference tree 210 as being different across the device configuration(s) for a given path and containing value(s), may resolve the difference by performing parametrization. For instance, the process 300A may add in parameters (e.g., template variables (e.g., such as XML template variables, or any other variables across a suitable template protocol) and/or location paths matching a service type schema of the device configuration generated by the orchestrator(s) 112, such as a service type schema generated in FIG. 3B). In some examples, the process 300A may refrain from parameterizing node(s) that are not list node(s) 206. For instance, for node(s) that comprise single value(s) and/or a variable, the orchestrator(s) 112 may use the original key value(s) of the node when generating template node(s). In some examples, the location paths work as processing instructions on where to find the service intent when it is mapped as device configuration.

As noted above, FIG. 3B may correspond to an example process 300B for performing part 2 of service type discovery. For instance, the example process 300B may be performed in order to generate a service type schema that defines how a network function (e.g., service type) can be provisioned by the orchestrator(s) 112. In some examples, one or more operations of process 300B may be performed independent of process 300A and/or process 300C. In some examples, one or more operations of process 300B may be performed prior to or following one or more of process 300A and/or process 300C.

At 310, the process 300B may include receiving the device schema. For instance, the process 300B may receive and/or access a copy of the device schema that is represented in a tree format. As an example and not by way of limitation, one or more portions of a device schema that is modelled based on a device YANG model may comprise and/or be represented as follows:
list policy-map {
   key name;
   leaf name
      {type string;
         }
      list class {
         key name;
         leaf name {
         type union {
         type string;
      leaf drop {
         type empty;
      }
      container estimate {
         container bandwidth {
         presence “bandwidth required to service this class”;
         container delay-one-in {
         leaf doi {
         type uint32 {
         range “50..1000000”;
         }
         }
         leaf milliseconds {
         type uint32 {
         range “8..1000”;
         }
         }
         }
         leaf drop-one-in {
         type uint32;
         }
         }
      }
      container priority {
         presence “”;
         leaf level {
         type uint8 {
         range “1..2”;
         }
         }
         choice priority-type {
         leaf kilo-bits {
         type uint32 {
         range “8..2000000”;
         }
         }
         leaf percent {
         type uint16 {
         range “1..100”;
         }
         }
         }
         leaf burst {
         type uint32 {
         range “32..64000000”;
         }
         }
         }
      }
   }

At 312, the process 300B may include generating a schema tree. For instance, the process 300B may generate the schema of the service type based on the location of parameterized nodes and the device schema used by the device configurations.

In some examples, the process 300B may include pruning the device schema tree such that only nodes that build up the location of parameterized nodes remain, thereby generating the schema tree.

In some examples, the structure of the schema tree may be based on and/or follow the structure as the device schema. In this example, the service input parameter(s) of the schema tree may be the same as the type of the affected device configuration node. For instance, the service type template may comprise the same service input parameter(s) (e.g., values for IP address, port, and/or any type of configuration setting).

By having the same service input parameters, the process 300B may map service input parameter(s) of the service type schema generated by the orchestrator(s) 112 to actual device configuration(s) that exist within the network. Further, the service input parameters may provide the orchestrator(s) 112 with additional information obtained directly from the device schema, including type and node descriptions, and dependencies on other schema nodes.

As an example and not by way of limitation, a service type schema generated by the process 300B (based on the device configuration(s) and/or device schema) may be represented as:
Module Policy-map-srv {
   yang-version 1.1;
   namespace “http: //com/example/policy-map-srv”;
   prefix policy-map-srv;
   import tailf-ncs {
      prefix ncs;
   }
   import tailf-common {
      prefix tailf;
   }
   import tailf-ned-cisco-ios {
      prefix ios;
      }
      list policy-map-srv {
         key name;
         uses ncs: service-data;
         ncs: servicepoint policy-map-srv;
         leaf name {
         type string;
         }
         leaf-list device {
         type leafref {
         path “/ncs:devices/ncs:device/ncs:name”;
         }
         }
         container policy-map {
         presence “”;
         container class {
         presence “”;
         container bandwidth {
         leaf percent {
         type ios:percentage-type;
         }
         }
         container estimate {
         container bandwidth {
         presence “”;
         container delay-one-in {
         leaf doi {
         type uint32 {
         range “50..1000000”;
         }
         }
         leaf milliseconds {
         type uint32 {
         range “8..1000”;
         }
         }
         }
         }
         }
         }
      }
   }
}

At 314, the process 300B may include generating code representing a service type. For instance, the process 300B may perform code generation for the service type by traversing the tree depth-first. The target of the code generation may be any modelling language (e.g., such as a modelling language that models hierarchical data, for example, the YANG modeling language, or any other suitable modelling language).

For instance, as an example and not be way of limitation, continuing the above example, the process 300B may generate the following intent to device configuration mapping that comprises XML template format:
<config-template xmlns=http://tail-f.com/ns/config/1.0
   servicepoint=“policy-map-srv”>
<devices xmlns=“http://tail-f.com/ns/ncs”>
   <device tags=“nocreate”>
      <name>{/device}</name>
      <config>
         <policy-map xmlns=“urn:ios”
         tags=“merge”>
         <name>a</name>
      </policy-map>
      <policy-map xmlns=“urn:ios”
         tags=“merge”>
         <name>map1</name>
         <class>
         <name>c1</name>
         <bandwidth>
         <percent>{/policy-map/class/bandwidth/percent}</percent>
         </bandwidth>
         <drop/>
         <estimate>
         <bandwidth>
         <delay-one-in>
         <doi>{/policy-map/class/estimate/bandwidth/delay-one-in/doi}</doi>
         <milliseconds>{/policy-map/class/estimate/bandwidth/delay-one-in/milliseconds}
</milliseconds>
   </delay-one-in>
      </bandwidth>
   </estimate>
   <priority>
      <percent>33</percent>
   </priority>
   </class>
   </policy-map>
   </config>
   </device>
   </devices>
</config-template>

Accordingly, the process 300B may generate a service type template that define(s) how a particular network function can be provisioned within the network(s) 102, in a language that the orchestrator(s) 112 can understand.

As noted above, FIG. 3C may correspond to an example process 300C for performing service instance discovery, according to the techniques described herein. In some examples, process 300C may be performed to discovering existing service intents deployed in the network by creating reverse mapping process instructions. For instance, process 300C may be used to create a reverse mapping that determines all valid service instances of the service types based on existing device configurations. Thus, the orchestrator(s) 112 may generate processing instructions to match the service type against the network. In some examples, one or more operations of process 300C may be performed independent of process 300A and/or process 300B. In some examples, one or more operations of process 300C may be performed prior to or following one or more operations of process 300A and/or process 300B.

At 316, the process 300C may include receiving input. In some examples, the input may comprise reference tree 210. For instance, the service type(s) generated by processes 300A and/or 300B may be deterministic, such that the service type(s) may map one-to-one to device configurations. By being deterministic, the output of the service type(s) may be determined by value(s) given as input parameters.

As noted herein, service input parameters may have the same hierarchy as the device configurations they map to. For instance, the hierarchy may extend to the input parameters of service instances. Accordingly, to avoid generating service instances that don't exist in the network(s) 102, the orchestrator(s) 112 may utilize reference tree 210.

At 318, the process 300C may include determining reverse mapping(s). For instance, the reverse mapping(s) may comprise a list of four-tuple(s). In some examples, the four-tuples may comprise one or more of constraint, variable binding, service input path, query. To determine the reverse mapping, the orchestrator(s) 112 may utilize one or more algorithm(s), such as a recursive algorithm that iterates breadth-first on the reference tree (or any other suitable algorithm).

In some examples, the process 300C may perform a breadth first search of the reference tree 210. For instance, the process 300C may start with an empty constraint-set on the root of the reference tree 210. If a particular node was identified as a reoccurring device configuration, a new four-tuple may be generated and added to the reverse mapping(s) list, where the new four-tuple comprises: the accumulated constraints, a newly generated variable name, service input path, and a query that selects device configurations while respecting the constraints. The process 300C may continue with the same set of accumulated constraints on the sibling nodes. In this example, the process 300C may use an updated constraint-set when visiting the children of the node (e.g., such as including the freshly calculated variable). Although the reverse mappings are described as being expressed as four-tuples, the reverse mappings may also be expressed with other representations or data, such as Java classes.

At 320, the process 300C may include sorting reverse mapping(s). For instance, the process 300C may first topologically sorted based on the constraint(s) in order to determine service instance(s).

As an example and not by way of limitation, an example of generated and sorted reverse mapping(s) of four-tuples (e.g., constraint, variable binding, service input path, query), may be represented as:

1. []
DEVICE
/device
/ncs:devices/device/name

### 2. [DEVICE]

No variable binding
/policy-map/class/bandwidth/percent
/devices/device[name=$DEVICE]/config/ios:policy-map[name=‘map1’]/class[name=‘c1’]/
bandwidth/percent

### 3. [DEVICE]

No variable binding /policy-map/class/estimate/bandwidth/delay-one-in/doi /devices/device[name=$DEVICE]/config/ios: policy-map[name='map1′]/class[name='c1′]/ estimate/bandwidth/delay-one-in/doi

### 4. [DEVICE]

No variable binding
/policy-map/class/estimate/bandwidth/delay-one-in/milliseconds
/devices/device[name=$DEVICE]/config/ios:policy-map[name=‘map1’]/class[name=‘c1’]/
estimate/bandwidth/delay-one-in/milliseconds

At 322, the process 300C may include determining service instance(s). For instance, the process 300C may include evaluating the reverse mapping list based on existing device configuration(s). For instance, the “constraints” may limit the search to existing device configuration. By limiting the search, the orchestrator(s) 112 may ensure that the process 300C does not generate false positive(s) of service instance(s).

It should be noted that the steps of process 300A, process 300B, and process 300C may be executed in different environments or on platforms. As example, the operations of process 300A and process 300B, as well as steps 316, 318, and 320, may be run in a lab or a test environment. However, step 322 may be run in a production environment of a customer and on a different host than the other steps.

As an example, and not by way of limitation, in the above example, evaluating the reverse mapping list may include and/or be represented as follows:
1. Evaluating the XPath query of the first reverse mapping tuple (/ncs:devices/device/name) gives the following node-set {asa0, ce0, ce1}.
2. Assigning asa0 to DEVICE and evaluating the second XPath query (/devices/device[name=$DEVICE]/config/ios: policy-map[name=‘map1’]/class[name=‘c1’]/bandwidth/percent) gives an empty node-set. The algorithm breaks the current loop, asa0 device doesn't have any device configuration that matches the service type.
3. Assigning ce0 to DEVICE and evaluating the second XPath query gives a one-element node-set {50}. The algorithm continues with the third and fourth XPath query that result in one-element node-sets, {500}, {100} respectively.
4. All XPath queries have resulted in a non-empty node-set, hence the algorithm creates the first service instance (policy-map-srv 1). It assigns ce 0 to/device, 50 to /policy-map/class/bandwidth/percent, 500 to policy-map/class/estimate/bandwidth/delay-one-in/doi, and 100 to policy-map/class/estimate/bandwidth/delay-one-in/milliseconds.
5. Assigning ce1 to DEVICE the algorithm continues with evaluating the second, third, fourth XPath query again. None of the resulting node-sets are empty, hence the algorithm creates the second service instance.

Where the discovered service instance(s) may be represented as follow(s):
policy-map-srv 1
   device [ce0]
   policy-map class bandwidth percent 50
   policy-map class estimate bandwidth delay-one-in doi 500
   policy-map class estimate bandwidth delay-one-in milliseconds 100
   !
   policy-map-srv 2
      device [ce1]
      policy-map class bandwidth percent 100
      policy-map class estimate bandwidth delay-one-in doi 400
      policy-map class estimate bandwidth delay-one-in milliseconds 200
      !

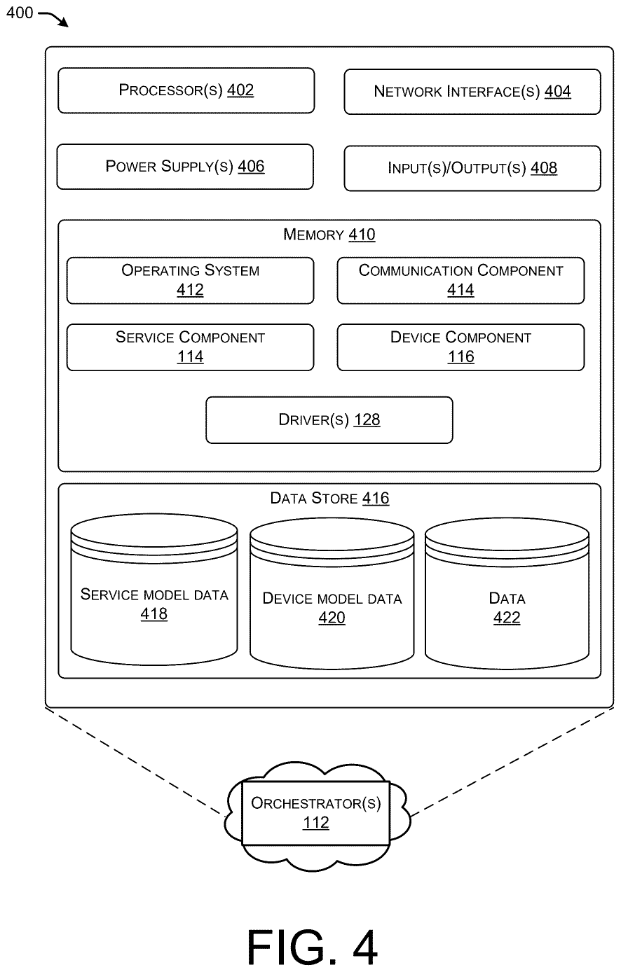

FIG. 4 illustrates a component diagram 400 of an example orchestrator (e.g., user device 108, network device 104, and/or orchestrator 112) configured to perform one or more functions, according to some aspects of the present disclosure. The orchestrator may be any type of computing device capable of receiving expressions of network functions via a network interface 404 and sending network commands to the network 110 via a suitable data communications network such as, but not limited to, a laptop or desktop computer, a tablet computing device, a server computer, a television, or a mobile telephone.

As illustrated, the orchestrator 112 may include one or more hardware processors 402 (processors), one or more devices, configured to execute one or more stored instructions. The processor(s) 402 may comprise one or more cores. Further, the orchestrator 112 may include one or more network interfaces 404 configured to provide communications between the orchestrator 112, and/or other systems or devices in the network(s) 102 and/or remote from the network(s) 102. The network interfaces 404 may include devices configured to couple to personal area networks (PANs), wired and wireless local area networks (LANs), wired and wireless wide area networks (WANs), and so forth. For example, the network interfaces 404 may include devices compatible with Ethernet, Wi-Fi, and so forth.

The orchestrator 112 can include one or more power supplies 406, such as one or more batteries, connections to mains power, etc. The orchestrator 112 can also include one or more inputs and outputs 408 for receiving and processing input from a number of input devices, such as a keyboard, a mouse, a touchpad, a touch screen, an electronic stylus, or other type of input device. Further, the input/outputs 408 can include a display, such as a computer monitor, a flat-panel display, a digital projector, a printer, or other type of output device. It will be appreciated that the orchestrator 112 might not include all of the components shown in FIG. 4, can include other components that are not explicitly shown in FIG. 4, or might utilize an architecture completely different than that shown in FIG. 4.

The orchestrator 112 may also include memory 410, such as computer-readable media, that stores various executable components (e.g., software-based components, firmware-based components, etc.). The memory 410 may generally store components to implement functionality described herein. The memory 410 may store an operating system 412 utilized to control the operation of components of the orchestrator 112. Further, the memory 410 may store a communication component 414 that comprises software (e.g., any protocol stack) to enable the orchestrator 112 to communicate with other devices using the network interface 404.

In some instances, the memory 410 may store a service component 114. The service component 114 may correspond to service component 114 of FIG. 1 and may perform operations as described herein. For instance, the service component 114 may comprise a human readable code or binary machine code that, when executed on the processor 402, may enable the orchestrator 112 to perform service type discovery, as described herein. In addition, the service component may enable the orchestrator 112 to perform service instance discovery, as described herein.

In some instances, the memory 410 may store a device component 116. The device component 116 may be configured to enable orchestrator 112 to perform one or more functionalities associated with device(s) in the network(s) 102. For instance, the device component 116 may be configured to determine and deliver configuration changes to network device(s) 104. The device component 116 may utilize a Southbound API to deliver changes to the network device(s) 104, such as via device abstraction(s) 126 (e.g., representations of the network device(s) 104), driver(s) 128, and/or any other suitable component.

In some examples, the memory 410 may store driver(s) 128. As described herein, the driver(s) 128 may be implemented as part of device abstraction(s) and comprise software package(s) associated with respective network device(s). The driver(s) 128 may implement a native device protocol of a network device while also providing a device model that comprises a configuration tree of the device configuration that is modeled in a particular schema language (e.g., such as YANG). The driver(s) may be configured to compute the ordered sequence of device-specific commands to go from a current to a desired state. Thus, the orchestrator may utilize the driver(s) to provide a uniform northbound API towards the devices and abstract the underlying protocol. Moreover, the driver(s) may enable a device component of the orchestrator to provide connection management, transactional configuration push, fine-grained configuration commands, and/or bidirectional device configuration synchronization

The orchestrator 112 may further include a data store 416, which may comprise any type of computer memory including long-term memory (e.g., Read Only Memory (ROM), Random Access Memory (RAM), caches, etc.). The data store 416 may include service model data 418 that tracks all currently running network services and stores associated state(s) and configuration(s) of the service(s) across network(s) 102. Further, the data store 416 may include device model data 420 that comprises tracking data associated with all currently running device(s) in the network(s) 102 and associated state(s) and configuration(s) of the device(s). The data store 416 may include data 422, which may comprise data and/or metadata associated with migration of service(s) to the orchestrator(s) 112, including, but not limited to, reference tree(s), node data, algorithm(s), count(s), schema(s), parameter(s), service type(s), service instance(s), service intent(s), input(s), schema tree(s), and/or any other data or metadata described herein.

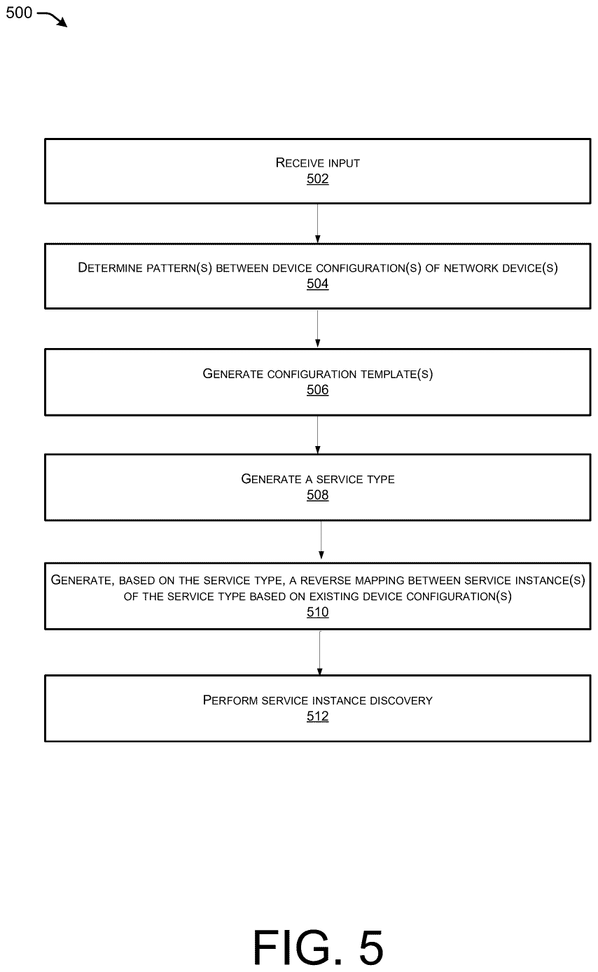

FIG. 5 illustrates a flow diagram of an example method 500 for performing automated detection of network services, according to the techniques described herein. In some instances, the steps of method 500 may be performed by a device (e.g., orchestrator(s) 112, etc.) that includes one or more processors and one or more non-transitory computer-readable media storing computer-executable instructions that, when executed by the one or more processors, cause the one or more processors to perform operations of method 500.

At step 502, the orchestrator may receive input. In some examples, the input may be received from a user device and/or workflow system(s). In some examples, the input may indicate a selection of one or more network devices (and/or device configuration(s)) of a plurality of network devices across the network. In some examples, the input further comprises a selection of the one or more device configurations and a recurrence rate. In some examples, the input is received as part of an initial network discovery when onboarding with a service provider of the network.

At step 504, the orchestrator may determine pattern(s) between device configuration(s) of network device(s). For instance, the orchestrator may perform service type discovery. In some examples, determining the one or more patterns further comprises: determining one or more structural differences in the one or more device configurations indicated by the input; and determining, based on the one or more structural differences, that configuration drift has occurred.

In some examples, determining the one or more patterns comprises: generating a reference tree representing the one or more device configurations, the reference tree comprising one or more nodes comprising an existing device configuration of the one or more device configurations, metadata information, and a counter.

At step 506, the orchestrator may generate a configuration template. In some examples, the configuration template may comprise a device schema including processing instructions indicating mappings between a service intent to the one or more device configurations across one or more devices in the network. In some examples, generating the configuration template further comprises: generating, based on the one or more patterns and a rate of recurrence, a matching configuration template for the service type comprising process instructions on how to map the service intent to the device configuration.

In some examples, generating the configuration template comprises: determining to prune one or more sub-trees of the reference tree based on a rate of recurrence; parameterizing one or more nodes comprising the metadata information indicating a difference in values between the one or more device configurations; and outputting the configuration template representing an intent to device configuration mapping that is used by the network controller to generate device configurations when deploying service instances. In this example, parameterizing the one or more nodes comprises inputting one or more template variables or location paths matching the schema.

At step 508, the orchestrator may generate a service type. In some examples, the service type comprises service type template 218 and/or service type(s) 118 as described herein. In some examples, the service type further comprises the configuration template and one or more location paths representing processing instructions indication where to find the service intent when mapped as the device configuration.

At step 510, the orchestrator may generate a reverse mapping between service instance(s) of the service type based on existing device configuration(s). In some examples, generating the reverse mapping(s) may comprise: receiving, by the network controller, the reference tree as input; for individual reoccurring device configuration identified in the reference tree: generating a four-tuple representing the reoccurring device configuration, the four-tuple comprising a constraint, a variable binding, a service input path, and a query; and storing the four-tuple as part of a list; and outputting the reverse mapping, the reverse mapping comprising the list.

At step 512, the orchestrator may perform service instance discovery. For instance, the orchestrator may perform service instance discovery in order to take ownership of the network device(s) and/or device configuration(s) and bring them into the lifecycle management of the orchestrator. In some examples, performing the service instance discovery comprises: determining one or more values to be passed as input to the service type to instantiate an instance of the service type that already exists in the network.

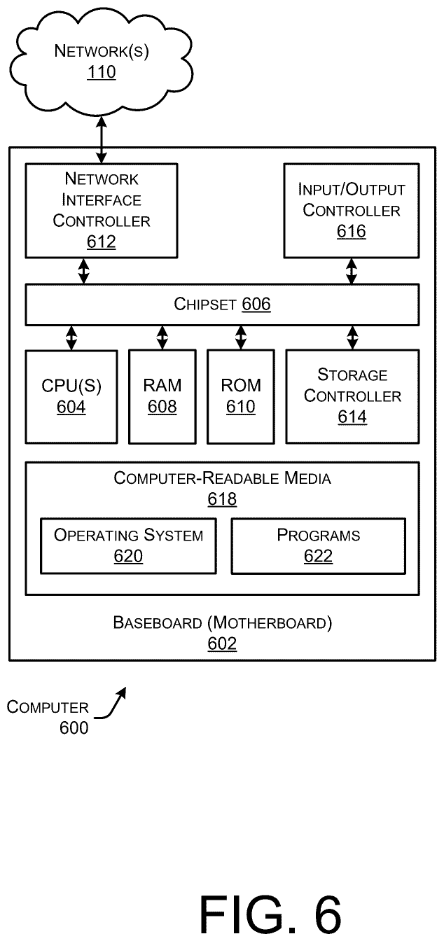

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer 600 may, in some examples, correspond to an orchestrator 112, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 102. The chipset 606 can include functionality for providing network connectivity through a NIC 612, such as a gigabit Ethernet adapter. The NIC 612 is capable of connecting the computer 600 to other computing devices over the network 110. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the orchestrator 112, and or any components included therein, may be supported by one or more devices similar to computer 600. Stated otherwise, some or all of the operations performed by orchestrator 112, and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIGS. 1-5, can include other components that are not explicitly shown in FIG. 6, or might utilize an architecture completely different than that shown in FIG. 6.

As described herein, the computer 600 may comprise one or more of a orchestrator 112 and/or any other device. The computer 600 may include one or more hardware processors (processors and/or CPUs 604) configured to execute one or more stored instructions. The processor(s) may comprise one or more cores. Further, the computer 600 may include one or more network interfaces configured to provide communications between the computer 600 and other devices, such as the communications described herein as being performed by the orchestrator 112. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for generating SNFs using a DSL and/or deploying SNFs to optimized network components.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a network controller of a network, comprising:
receiving, from a user device, input indicating one or more network devices of a plurality of network devices across the network;
determining, based on the input, one or more patterns between one or more device configurations of the one or more network devices;
generating, based on the one or more patterns, a configuration template comprising a device schema including processing instructions indicating mappings between a service intent to the one or more device configurations across one or more devices in the network;
generating, based in part on the configuration template, a service type comprising a schema representing a device configuration of the service type;
generating, based on the service type, a reverse mapping between one or more service instances of the service type based on existing device configurations within the network, the reverse mapping comprising a list of service intents deployed in the network; and
performing, based on the reverse mapping, service instance discovery to take ownership of the device configuration to the network controller.

2. The method of claim 1, wherein the service type further comprises the configuration template and one or more location paths representing processing instructions indication where to find the service intent when mapped as the device configuration.

3. The method of claim 1, wherein generating the configuration template further comprises:
generating, based on the one or more patterns and a rate of recurrence, a matching configuration template for the service type comprising process instructions on how to map the service intent to the device configuration.

4. The method of claim 1, wherein:
determining the one or more patterns comprises:
generating a reference tree representing the one or more device configurations, the reference tree comprising one or more nodes comprising an existing device configuration of the one or more device configurations, metadata information, and a counter; and
generating the configuration template comprises:
determining to prune one or more sub-trees of the reference tree based on a rate of recurrence;
parameterizing a subset of the one or more nodes comprising the metadata information indicating a difference in values between the one or more device configurations; and
outputting the configuration template representing an intent to device configuration mapping that is used by the network controller to generate device configurations when deploying service instances.

5. The method of claim 4, wherein parameterizing the one or more nodes comprises inputting one or more template variables or location paths matching the schema.

6. The method of claim 4, wherein determining the reverse mapping comprises:
receiving, by the network controller, the reference tree as input;
for individual reoccurring device configuration identified in the reference tree:
generating a four-tuple representing the individual reoccurring device configuration, the four-tuple comprising a constraint, a variable binding, a service input path, and a query; and
storing the four-tuple as part of a list; and
outputting the reverse mapping, the reverse mapping comprising the list.

7. The method of claim 1, wherein performing the service instance discovery comprises:
determining one or more values to be passed as input to the service type to instantiate an instance of the service type that already exists in the network.

8. The method of claim 1, wherein the input further comprises a selection of the one or more device configurations and a recurrence rate.

9. The method of claim 1, wherein determining the one or more patterns further comprises:
determining one or more structural differences in the one or more device configurations indicated by the input; and
determining, based on the one or more structural differences, that configuration drift has occurred.

10. The method of claim 1, wherein the input is received as part of an initial network discovery when onboarding with a service provider of the network.

11. A system comprising:
one or more processors; and
one or more non-transitory computer-readable media storing computer-executable instructions that, when executed by the one or more processors, cause the one or more processors to perform operations comprising:
receiving, from a user device, input indicating one or more network devices of a plurality of network devices across a network;
determining, based on the input, one or more patterns between one or more device configurations of the one or more network devices;
generating, based on the one or more patterns, a configuration template comprising a device schema including processing instructions indicating mappings between a service intent to the one or more device configurations across one or more devices in the network;
generating, based in part on the configuration template, a service type comprising a schema representing a device configuration of the service type;
generating a reverse mapping between one or more service instances of the service type based on existing device configurations within the network, the reverse mapping comprising a list of service intents deployed in the network; and
performing, based on the reverse mapping, service instance discovery.

12. The system of claim 11, wherein the input is received as part of an initial network discovery when onboarding with a service provider of the network.

13. The system of claim 11, wherein the input further comprises a selection of the one or more device configurations and a recurrence rate.

14. The system of claim 11, wherein determining the one or more patterns further comprises:
determining one or more structural differences in the one or more device configurations indicated by the input; and
determining, based on the one or more structural differences, that configuration drift has occurred.

15. The system of claim 11, wherein the service type further comprises the configuration template and one or more location paths representing processing instructions indication where to find the service intent when mapped as the device configuration.

16. The system of claim 11, wherein:
determining the one or more patterns comprises:
generating a reference tree representing the one or more device configurations, the reference tree comprising one or more nodes comprising an existing device configuration of the one or more device configurations, metadata information, and a counter; and
generating the configuration template comprises:
determining to prune one or more sub-trees of the reference tree based on a rate of recurrence;
parameterizing a subset of the one or more nodes comprising the metadata information indicating a difference in values between the one or more device configurations; and
outputting the configuration template representing an intent to device configuration mapping that is used by a network controller to generate device configurations when deploying service instances.

17. The system of claim 16, wherein parameterizing the one or more nodes comprises inputting one or more template variables or location paths matching the schema.

18. The system of claim 16, wherein determining the reverse mapping comprises:
receiving the reference tree as input;
for individual reoccurring device configuration identified in the reference tree:
generating a four-tuple representing the individual reoccurring device configuration, the four-tuple comprising a constraint, a variable binding, a service input path, and a query; and
storing the four-tuple as part of a list; and
outputting the reverse mapping, the reverse mapping comprising the list.

19. The system of claim 11, wherein performing the service instance discovery comprises:
determining one or more values to be passed as input to the service type to instantiate an instance of the service type that already exists in the network.

20. One or more non-transitory computer-readable media storing computer-readable instructions that, when executed by one or more processors, cause the one or more processors to perform operations comprising:
receiving, from a user device, input indicating one or more network devices of a plurality of network devices across a network;
determining, based on the input, one or more patterns between one or more device configurations of the one or more network devices;
generating, based on the one or more patterns, a template comprising a device schema including processing instructions indicating mappings between a service intent to the one or more device configurations across one or more devices in the network;
generating, based in part on the template, a service type comprising a schema representing a device configuration;
generating, based on the service type, a reverse mapping between one or more service instances of the service type based on existing device configurations within the network, the reverse mapping comprising a list of service intents deployed in the network; and
performing, based on the reverse mapping, service instance discovery.
